(19) United States
(12) Patent Application Publication
(10) Pub. No.: US 2015/0113765 A1
(43) Pub. Date: Apr. 30, 2015

(54) BALL CASTER ASSEMBLY FOR A WHEELCHAIR APPLICATION

(71) Applicant: Leelund Perry, Everett, WA (US)

(72) Inventor: Leelund Perry, Everett, WA (US)

(21) Appl. No.: 14/061,879

(22) Filed: Oct. 24, 2013

(51) Int. Cl. A61G 5/10; B60B 33/08

(52) U.S. Cl. CPC A61G 5/10; B60B 33/08
USPC 16/28

(57) ABSTRACT

A ball caster assembly for a wheelchair that includes a ball caster; and a ball support, where the ball support includes a post that supports and attaches to the ball caster to secure it within the ball caster assembly. Further at the top of the ball support a base is provided with a stem extending vertically from the base. The stem allows for the insertion of the ball caster wheel assembly including opening socket of the wheelchair.

### BACKGROUND OF THE INVENTION

1. Field of Invention

The present invention relates to the use of a ball caster assembly as a device to replace the conventional wheelchair wheel.

2. Description of Related Art

Wheelchairs typically are placed on standard wheels for movement over a surface. Typically a wheelchair wheel is a standard wheel with an axle and a round surface usually made of rubber or hard plastic materials. Typically the wheelchair includes larger wheels that form the base of the wheelchair and smaller wheels that swivel to enable steering of the wheelchair from left to right. A common problem associated with the swiveling wheels is that the wheels get stuck on various surfaces, in particular soft surfaces. Soft surfaces allow for the sinking of the wheel into the surface, and therefore make it tougher for an individual to maneuver with the wheelchair. Consequently a substitute for the traditional swivel wheel is therefore needed.

### SUMMARY OF THE INVENTION

The present invention relates to a ball caster assembly for a wheelchair that includes a ball caster; and a ball support, where the ball support includes a post that supports and attaches to the ball caster to secure it within the ball caster assembly. Further at the top of the ball support a base is provided with a stem extending vertically from the base. The stem allows for the insertion of the ball caster wheel assembly including opening socket of the wheelchair.

### BRIEF DESCRIPTION OF DRAWINGS

FIG. 1 depicts a front view of a ball caster assembly in accordance with the present events.

FIG. 2 depicts a side view of a ball caster assembly in accordance with the present events.

### DETAILED DESCRIPTION

The present invention relates to a ball caster assembly that enables the user to replace traditional swivel wheels that are normally placed on a wheelchair. The ball cast assembly includes a ball-shaped wheel, i.e., a ball caster that is supported within a ball support. A post is provided that attaches the ball caster assembly support in enabling the placement of the assembly into a traditional wheelchair. A stem extends from the base that is provided at the top of the ball support that therefore provides for the complete support of the ball assembly.

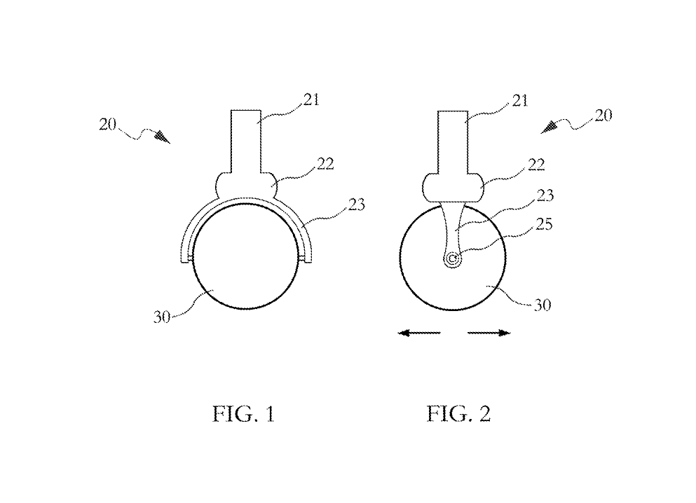

In reference to FIG. 1, a front view of a ball caster assembly 20 in accordance with the present invention is depicted. This ball caster assembly 20 includes a ball caster 30. The ball caster 30 is attached to a ball support 23 that extends around a portion of the circumference of the ball caster 30 and is held in place with a post 25. At the top of the ball support 23 is a base 22 with a stem 21 extending vertically from the base 22. This base 22 for the stem 21 is placed into a socket of a wheelchair and stabilizes the ball caster 30 within the socket for use on the wheelchair. In reference to the side view of the ball support 23 is provided along with the post 25. Further arrows provided to depict the movement of the ball caster when attached within the ball support as shown.

The ball cast assembly according to present invention involves a complete replacement for the traditional wheelchair wheel and therefore enables the movement of the wheelchair with a ball caster-type wheel is shown. In particular the ball caster wheel may be 4 to 5 inches in diameter to provide adequate support and maneuverability for the user. Further the ball caster wheel may be manufactured of a recycled polyethylene plastic as a suitable material to support an individual in a wheelchair.

What is claimed is:

1. A ball caster assembly for a wheelchair comprising:
a ball caster;
a ball support, a ball support includes a post where the post supports and attaches the ball caster to the ball caster assembly;
a base at the top of the ball support; and
a stem extending from the base.

2. The ball caster assembly according to claim 1, where the ball support extends over about 6 percent of the ball caster circumference.

3. The ball caster assembly according to claim 1, where the ball caster measures in a range of about 4 to 5 inches in diameter.

4. The ball caster assembly according to claim 1, where the ball is made of a recycled polyethylene plastic.
